(19) United States
(12) Patent Application Publication
(10) Pub. No.: US 2019/0392405 A1
(43) Pub. Date: Dec. 26, 2019

(54) CORRELATING E-RECEIPTS TO TRANSACTION ENTRIES

(71) Applicant: International Business Machines Corporation, Armonk, NY (US)

(72) Inventors: William Yates, Portsmouth (GB); Adam J. Reeves, Loughton (GB); Thomas E. Slattery, Eastleigh (GB)

(21) Appl. No.: 16/018,111

(22) Filed: Jun. 26, 2018

(51) Int. Cl. G06Q 20/04; G06Q 20/38; G06Q 20/10; G06F 17/30

(52) U.S. Cl. CPC G06Q 20/0453; G06F 17/30887; G06Q 20/108; G06Q 20/3827

(57) ABSTRACT

A method, system, and computer program product for generating and displaying comprehensive transaction information is disclosed. Operands including transaction-specific details from an electronic receipt and a pre-shared salt are hashed to produce a unique purchase identifier (PID). A user may submit the electronic receipt to a transaction recorder who also possesses the pre-shared salt. The transaction recorder may create a duplicate of the PID using the electronic receipt and the pre-shared salt. The duplicate PID may be associated with transaction entry stored in a transaction database.

### BACKGROUND

Currently, a transaction on a bank statement generally shows the name of vendor, the amount of the transaction, and the date. However, there is no way of accessing or viewing the full receipt of the transaction from the statement. This can lead to a common problem in which someone looking at a transaction within their bank statement is unsure of what exactly they bought. In other situations, that person may need a copy of the receipt (e.g. if they need to return the item to the vendor).

Although some merchants produce an e-receipt which is emailed to the customer, this is not integrated with the customer's online bank statements and requires separate filing and organization on the part of the user.

U.S. Pat. No. 8,296,229 B1 describes a system for collecting e-receipts in a central database. Merchants and customers can enroll in the database and are allocated unique merchant and customer identifiers. The e-receipt database then correlates purchases between merchants and customers. Customers then have access to their e-receipts in a way that is correlated to merchants. However, integration to banks is not provided.

In theory, a straightforward solution would be for the merchants to transmit the e-receipts to the banks. That is, during a purchase made by a customer with a card, as part of the data exchange between the bank and the merchant for verifying the purchase, the merchant transmits an e-receipt of the purchase to the bank. However, the amount of data in an e-receipt is much larger than the card data needed to verify a purchase, so existing systems may be strained or unable to support such an approach.

### SUMMARY

According to one aspect of the disclosure, there is provided a computer-implemented method associated with a purchase involving a merchant, a customer and a bank (e.g., a transaction recorder), the customer having a bank account with the bank, the merchant having an identifier with the bank, and the purchase being made with the bank account. The method comprises: the merchant generating an e-receipt containing a set of operands needed by a hashing algorithm, the set of operands having values that permit the hashing algorithm to calculate a unique purchase identifier, PID, for that purchase. The merchant then transmits the e-receipt to the customer. The customer receives and stores the e-receipt in an e-receipt storage, wherein the e-receipt storage may take a variety of forms including third-party cloud storage, or local storage of the customer. The bank meanwhile generates a bank transaction entry for the purchase including the set of operands with said values for that purchase and storing the bank transaction entry in a transaction database.

The ability to link receipts to bank transactions is useful to customers, since it provides a detailed breakdown of spending. For the same reason, it is also a valuable service to a bank, since it provides their customers with a useful service.

An advantage of our method is that a unique PID for each purchase can be generated by both the merchant and the bank independently of each other, so it is not necessary to communicate the PID between the merchant and bank at the time of purchase, which would be undesirable since it would require changing the merchant-bank protocol that is currently used for verifying purchases. It is also not necessary to embed the PID into the e-receipt, since the customer can use the PID for indexing the e-receipt. It is further not necessary to store the PID at the bank alongside the transaction, since storing values for the hashing algorithm's operands is sufficient to allow the PID to be calculated on demand whenever needed.

It is convenient that the operands are based upon parameters that would be in a normal e-receipt, and moreover parameters that are actually in the e-receipt for which the PID has been and/or is in future to be calculated by various copies of the hashing algorithm possessed by the different system actors: merchant, bank or customer; or a third party service acting as an agent for one or more of the merchant, bank or customer.

In some embodiments the merchant has a copy of the hashing algorithm and applies the hashing algorithm to hash said operands to generate said PID. Further, the merchant who is transmitting the e-receipt to the customer makes use of said PID by creating a unique resource location, URL, containing the PID to provide an index for storing the e-receipt by the customer, which can then be later used for retrieving the e-receipt from the storage.

In some embodiments, the bank has a copy of the hashing algorithm and applies the hashing algorithm to hash said operands to generate a duplicate of said PID generated by the merchant.

The customer may later access said bank transaction entry using a computing device, e.g. in an online banking portal or app. The customer's computing device can be used to match the PID for the bank transaction entry calculated by the hashing algorithm with the corresponding PID for the customer's e-receipt storage in order to link the bank transaction entry with the corresponding e-receipt.

For example, the hashing operands may include operands selected from the group: a bank account identifier associated with the customer's bank account; a merchant identifier; a purchase value amount; a date/time stamp; and a salt. The salt will have been pre-shared between the customer, the bank, and the merchant. A number of the operands that are specific to the purchase have values that are shared between the bank and the merchant at the time of purchase in the course of verifying the payment, so are both automatically available to the bank and the merchant at the time of purchase without any additional infrastructure or modification to existing infrastructure being necessary.

According to another aspect of the disclosure there is provided a merchant system for supporting a purchase involving a merchant, a customer and a bank, the customer having a bank account with the bank, the merchant having an identifier with the bank, and the purchase being made with the bank account. The system comprises: a memory in which a hashing algorithm is stored, the hashing algorithm being operable to generate a purchase identifier, PID, that is unique to a purchase by hashing a plurality of operands having values specific to the purchase; a processor operable to execute the hashing algorithm; an e-receipt generator operable to generate an e-receipt containing the set of hashing operands needed by the hashing algorithm to calculate the unique PID for that purchase; and a transmitter operable to transmit the e-receipt to a customer device.

According to still further aspect of the disclosure there is provided a transaction support system hosted by a bank for supporting purchases involving the bank, merchants and customers who have bank accounts with the bank, the merchants each having an identifier with the bank, and each purchase being made with one of the bank accounts. The bank's transaction support system comprises: a hashing algorithm operable to hash a set of operands having values specific to a purchase; a processor operable to execute the hashing algorithm; and a transaction database operable to store bank transaction entries for the purchases, each purchase being stored together with a set of the hashing operands which are thus able to be used on demand by a hashing algorithm to calculate a unique PID for that purchase. The bank transaction support system in some embodiments comprises: a memory in which the hashing algorithm is stored; and a processor operable to execute the hashing algorithm.

The bank transaction support system may further comprise a bank statement generator for generating an online bank statement for a customer in which bank transaction entries are associated with the PIDs calculated by the hashing algorithm, the PIDs being accessible by the customer. The bank statement generator in some embodiments is further operable during a session in which a customer is logged into the transaction support system to: access a customer e-receipt storage; search the customer e-receipt storage for e-receipts associated with PIDs that match PIDs generated by the bank for transaction entries; and upload from the customer e-receipt storage e-receipts with matching PIDs and store the e-receipts in the transaction database associated with their corresponding transaction entries.

According to another aspect of the disclosure there is provided a customer device for integrating e-receipts with bank statements, wherein the e-receipts relate to purchases involving merchants, a customer and a bank, the customer having a bank account with the bank, the merchant having an identifier with the bank, and the purchases having been made with the bank account. The customer device comprises: an e-receipt storage operable to receive and store e-receipts generated by merchants in the course of e-commerce purchases made by the customer using the bank account, the e-receipts being associated with a set of operands such that each e-receipt is associated with values for the operands from which a hashing algorithm is able to calculate a PID unique to that purchase; and a support application configured to cooperatively communicate with a banking application to link bank transaction entry information with the customer's e-receipts, wherein the bank transaction entry information is made up of transaction entries associated with purchases stored by the bank with values of the set of operands for each purchase, the support application being operable to integrate the transaction entries with the e-receipts stored in the e-receipt storage by applying the hashing algorithm to match corresponding PIDs between a paired transaction entry and e-receipt.

In some embodiments, the customer device is further operable to download transaction entry data from the banking application and merge the e-receipts into the transaction entries by matching the corresponding PIDs.

According to other aspects of the disclosure, there is provided respective computer programs stored on a computer readable medium and loadable into the internal memory of the respective customer device, the merchant system, and the bank system, comprising software code portions, when said program is run on the customer device, the merchant system, or the bank system, for performing the relevant parts of the above-defined method. A computer program product may also be provided which stores the above-mentioned computer programs.

### BRIEF DESCRIPTION OF THE DRAWINGS

In the following, the present invention will further be described by way of example only with reference to exemplary embodiments illustrated in the figures.

FIG. 1 is a schematic drawing of an embodiment of the disclosure showing a bank system, a merchant system, and a customer device suitable for executing a purchase in an electronic transaction environment, according to embodiments of the present disclosure.

FIG. 2 is a schematic drawing of the bank system and customer device of FIG. 1 in the context of post-purchase access of the customer to an online banking service to view transactions relating to earlier purchases, according to embodiments of the present disclosure.

FIG. 3 is a flow diagram of a process for generating and storing a unique PID and e-receipt, according to an embodiment.

FIG. 4 is a flow diagram of bank system activity that takes place in connection with the generating and storing of FIG. 3, according to embodiments.

FIG. 5 is a flow diagram of a process that takes place when the customer wishes to view transaction activity in his or her account, according to embodiments.

FIG. 6 illustrates a high-level block diagram of an example computer system that may be used in implementing embodiments of the present disclosure.

FIG. 7 depicts a cloud computer system according to an embodiment of the disclosure.

FIG. 8 depicts abstraction model layers according to an embodiment of the disclosure.

### DETAILED DESCRIPTION

In the following detailed description, for purposes of explanation and not limitation, specific details are set forth in order to provide a better understanding of the present disclosure. It will be apparent to one skilled in the art that the present disclosure may be practiced in other embodiments that depart from these specific details. For example, while a scenario of purchase and banking transactions is employed, the disclosure may be further used in inventory and order tracking, among other applications.

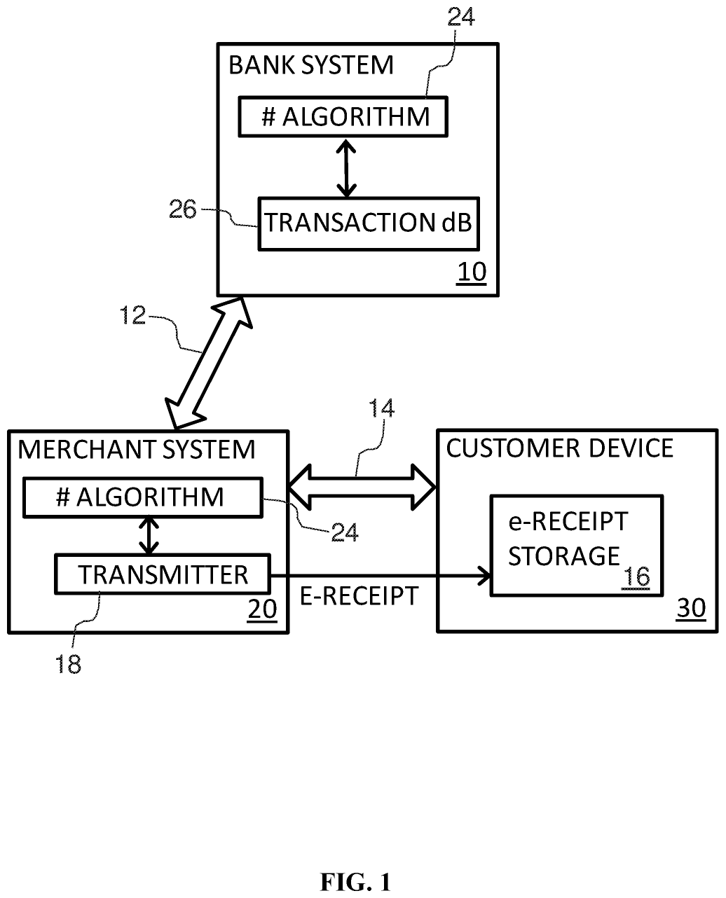

FIG. 1 is a schematic drawing of an embodiment of the disclosure showing the main components needed to execute a purchase in an electronic transaction environment, namely a bank system 10, a merchant system 20, and a customer device 30. The merchant system 20 may be a point-of-sale (POS) terminal in a conventional store or an online shop. The customer device 30 may be a smart phone, tablet, or personal computer. The scenario considered is an e-commerce purchase involving a merchant, a customer, and a bank acting through the respective above-mentioned systems and devices 10, 20, and 30. The customer has a bank account with the bank. The merchant has an identifier with the bank. The purchase is made through payment from the customer's bank account.

The bank system 10 hosted by the bank has the role of supporting e-commerce transactions involving the bank, specifically its customers' purchases from merchant systems. The bank's transaction support system 10 has a memory in which a hashing algorithm 24 is stored and a processor operable to execute the hashing algorithm 24. The hashing algorithm 24 is active during a purchase to generate a purchase identifier (PID) that is unique to a bank transaction entry associated with the particular purchase. The unique PID in certain embodiments may be contained within (e.g., form a part of) a link (e.g., a hyperlink), as shown in the example below. To generate the PIDs the hashing algorithm 24 hashes a plurality of operands having values specific to that purchase. An example set of hashing operands may be: a bank account identifier associated with the customer's bank account; the merchant identifier; a purchase value amount; a date/time stamp; and a salt. In embodiments, the set of hashing operands may include additional data, such as GPS coordinates of the purchase, the specific currency type involved, payment method type (e.g., credit card, debit card, EFT, etc.), etc. A salt is random data that is used as an additional input to a one-way function that “hashes” data, a password, or a passphrase. In embodiments, a salt is a persistent ‘shared’ secret that is known by all three parties and acts as a salt when calculating the hash. If a salt is used as one of the operands, then it will have been pre-shared between the customer, the bank, and the merchant (e.g., by network distribution in the manner of a cryptographic key). The design is flexible as to which information items and combinations should be used for the hash operands, so this can be chosen as desired.

The merchant system 20 also has a memory and processor for storing and executing the same hashing algorithm 24 as the bank system 20, using the same set of operands. In the course of a purchase, purchase data to specify the purchase and authorize the payment will flow between the merchant and bank as indicated by double-headed arrow 12 and between the merchant and the customer (e.g., for payment card verification), as indicated by double-headed arrow 14. The conventional purchase data shared between the merchant and the bank is therefore used for the operands of the hashing algorithm (other than the pre-shared salt). The hashing algorithm 24 at the bank will therefore be able to generate the same hash value as the hashing algorithm at the merchant by using the same algorithm with the same set of operands. A PID that is unique to the purchase can then be generated independently both by the bank and the merchant.

After a purchase has been made, the merchant then applies an e-receipt generator to generate an e-receipt containing the set of operands needed by the hashing algorithm to calculate the unique PID for that purchase. A transmitter 18 of the merchant system then transmits the e-receipt to the customer. The e-receipt includes values for the set of operands, so that when desired at some later time, a copy of the hashing algorithm can compute the unique PID from the e-receipt. The e-receipt additionally includes further details of the purchase (e.g., the model number and serial number of the purchased item, contact details of the merchant, third party responsible for warranty fulfillment, etc.). The customer then stores the e-receipt in a storage 16. Although shown in FIG. 1 as being part of a customer device 30, the customer's e-storage 16 may be either local to a particular device, as illustrated, and/or distributed (e.g., in cloud storage). For example, the customer's e-receipt storage may be integrated in an app dedicated to the purpose of storing e-receipts, an app provided by the customer's bank, or in a general cloud storage account held by the customer, such as Microsoft OneDrive, Google Drive, Dropbox, etc. A further alternative is that a third party service holds the e-receipts on behalf of the customer, and the merchant transmits the e-receipts directly to the third party. Companies could then specialize in providing such third party e-receipt storage services.

When the purchase is an online purchase conducted with a customer device in the form of a smart phone, personal computer, or the like, the e-receipt can be transmitted from the merchant to the customer directly via the communication link established to effect the purchase (e.g., within a website session between the customer and the online shop).

When a conventional in-store purchase made with a bank card or an electronic wallet of a smart phone app interacting with a merchant POS terminal, the e-receipt may be transmitted to the customer through a separate communication link. For example, the merchant may use email, SMS, or another form of messaging service (e.g., through a social network), to transmit the e-receipt to the customer. Alternatively, if an electronic wallet of a smart phone app has been used to make the payment in the in-store purchase, then the merchant may use the same near field communication link established for payment verification between the merchant and smart phone to transmit the e-receipt to the customer's smart phone. In embodiments, the merchant may use a second near field communication link, which may employ encryption techniques for data transfers, established specifically for the purpose of providing the e-receipt, to incorporate a higher level of security.

The bank account identifier may be a card number of a bank card possessed by the customer, an identifier associated with a mobile phone linked to the customer via a SIM card, biometric data of the customer (e.g., voice, iris scan, fingerprint, face scan, etc.) or any other secure form of identifier or combination thereof or derivative therefrom (e.g., a transaction authentication number (TAN) code).

The net result is that, after the purchase, the same unique PID is possessed by both the bank and the customer. In the case of the bank, the set of operand values needed for later PID calculation by a copy of the hashing algorithm is stored in a transaction database 26, which associates the transaction entry for the purchase with the set of operand values. In the case of the customer, the customer has a store 16 of e-receipts, each of which includes operand values needed by a hashing algorithm to calculate the unique PID associated with the purchase to which the e-receipt pertains.

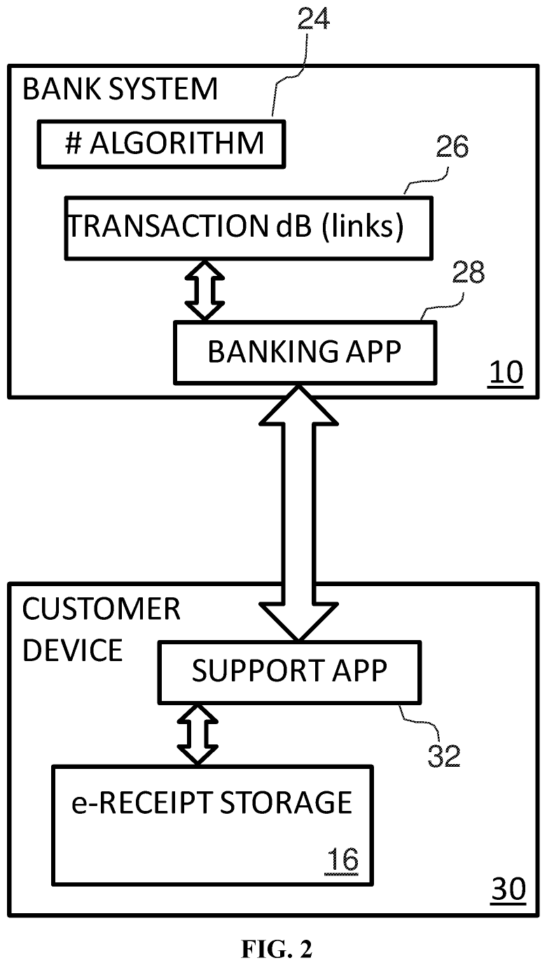

FIG. 2 is a schematic drawing of the bank system 10 and customer device 30 of FIG. 1 in the context of post-purchase access of the customer to an online banking service delivered by the bank system 10 through a banking application 28. The customer device 30 hosts a support application 32 which operates cooperatively with the banking application 28. The customer 30 initiates an online session to access the banking application 10 and thereby gain access to the customer's account information (e.g., to view recent transactions, or transactions selected by a filter). This may be done with some form of a bank statement format visual on-screen presentation or file download of a bank statement.

The term ‘bank statement’ in this document means a computer file containing information on one or more transactions, wherein the computer file may be presented on a computer screen as a list of transactions, or may be made available to a computer program in any other form that the computer program can read its contents (e.g., a scan of a paper bank statement processed with optical character recognition and natural language processing techniques to provide machine-readable data representing the contents of the statement).

When the customer views or otherwise accesses a transaction entry in the bank statement, the customer support app 32 has access to the customer e-receipt storage 16, with each e-receipt having stored therein its set of operand values for computing its PID. The banking app 28 has access to the transaction entries of transaction database 26, also with the hashing algorithm operand values 24 needed for calculating the PID. The customer's support app 32 can therefore operate cooperatively with the bank's banking app 28 to pair bank transaction entries with corresponding e-receipts via finding e-receipts in the e-receipt storage 16 and transaction database 26 that have matching PIDs. The PID computations may be done on the fly by the hashing algorithm as needed to support user activity. It is therefore possible for the banking app 28 to present to the customer an integrated view in which the bank transaction entries have integrated with them their respective e-receipts. Moreover, it is further possible that when a customer downloads a computer file containing a bank statement, the customer's support app 32 can perform integration of the e-receipts into the bank statement file at the customer end to create a modified bank statement computer file with the e-receipt information appended to each bank transaction entry.

Still further, the banking app 28 may be provided with functionality to upload the e-receipt data from the customer. For example, during a session in which a customer is logged into the banking system 10, the customer may give permission to the bank system 10 to access the customer's e-receipt storage 16. The bank system 10 may then search the customer e-receipt storage 16 for e-receipts that give PIDs that match PIDs calculated from the transaction database 26 against transaction entries in the transaction database 26. Matching e-receipts are then uploaded to the bank system 10 from the customer e-receipt storage 16. The bank can then add the e-receipts to the transaction database 26 associated with their corresponding transaction entries.

The customer's support application 32 may be a stand-alone application, or a plug-in or add-on to a bank's online portal to provide the above-described added functionality for the customer.

If the bank system 10 is configured to access the customer's e-receipt storage 16 and upload all e-receipts that match transactions, then the bank can merge its own transaction entry data, which it collected as part of the payment authorization cycle at the time of purchase, with the e-receipt data.

If this merger is done, then afterwards the bank system 10 may choose to delete the hashing operand values from its record of the purchase, since the transaction entry and e-receipt are now united. Similarly, once such a merger has been made, the equivalent data held by or for the customer may also be deleted. With the upload implementation, the bank does, in the end, obtain all the e-receipt data, but without the data having to have been sent to the bank by the merchant at the point of sale. Rather, the bank receives the e-receipt data from the customer, and then only with the customer's positive permission to allow the e-receipt data to flow to the bank from the customer's e-receipt storage.

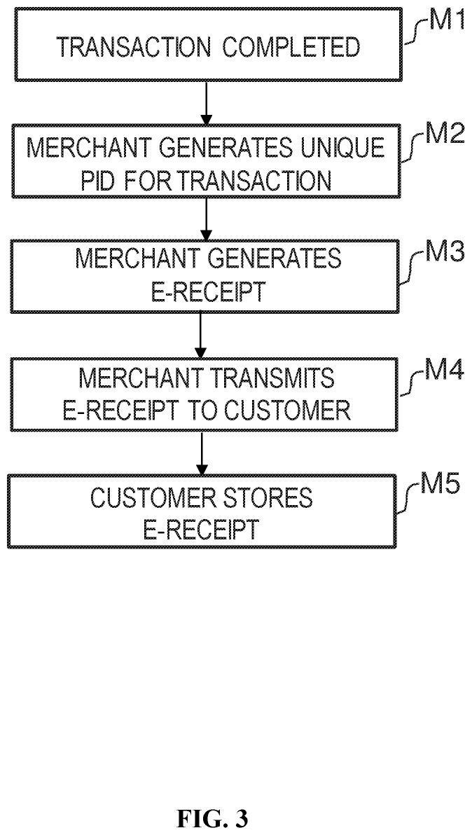

FIG. 3 is a flow diagram of a process for generating and storing a unique PID and e-receipt, according to an embodiment.

Initially, in Step M1, the customer (e.g., bank card holder) successfully makes a payment using conventional payment infrastructure and methods thereby to complete a transaction.

In Step M2, in addition to the conventional e-commerce transaction steps between merchant, bank, and customer, the merchant generates a unique PID for the purchase. For example, the operands that may be used could be: date/time stamp, card number, merchant ID, amount transacted, and/or a known ‘salt’ that has been pre-shared between the customer, merchant, and the bank is passed into the hashing algorithm. Alternative operands are contemplated, above. The provided information is then hashed. The unique PID is produced by the hashing algorithm from the values of an appropriate set of such operands.

In Step M3, the merchant generates an e-receipt for the purchase.

In Step M4, the merchant transmits the e-receipt to the customer. In embodiments, the merchant may transmit the e-receipt to the customer by creating a unique resource location (URL) containing the PID to provide an index for storing the e-receipt at the customer end. The URL is then used to upload the e-receipt to a shared service, either on the customer's device or held by a third party. In embodiments where the PID is contained in a URL, the URL itself will uniquely index the e-receipt.

In Step M5, the customer device stores the e-receipt in an e-receipt storage (e.g., e-receipt storage 16 of FIG. 2). It is noted that it is not necessary for the PID to be stored at the customer end, specifically. Doing so may, in embodiments, lead to lack of flexibility, since it is desirable that the e-receipt is permitted to adopt any suitable file format (e.g., pdf, png, or text), and it might not be easily possible to extract the operands from the e-receipt directly. For example, the merchant can issue a POST request using RESTful techniques to a URL that contains the PID to request, so that the e-receipt attached to the request can be stored. The bank can then also calculate the PID and send a GET request to a URL that contains the PID to allow the user to retrieve the e-receipt.

### EXAMPLE

| date/time | card | merchant | transaction | |
|---|---|---|---|---|
| stamp | number | ID | amount | salt |
| 2017/09/15 | 12345678901 | ABCDEFG | $49.99 | thisisasalt1 |
| 14:00 | | | | |

The hash could then be, for example, the following string:
76fab2ba18777d50d7e65f894d456173
   which could then be used as part of a unique resource locator (URL) that constitutes the unique PID link. For example, the link could in this example be:
https://domain/eReceipt/76fab2ba18777d50d7e65f894d456173

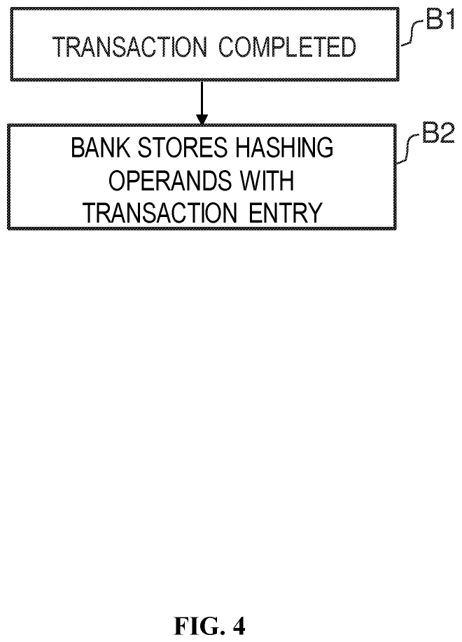

FIG. 4 is a flow diagram of bank system activity that takes place in connection with the generating and storing of FIG. 3.

Initially, in Step B1, the customer (e.g., bank card holder) successfully makes a payment in connection with a purchase using conventional payment infrastructure and methods thereby to complete a transaction.

In Step B2, at the bank end, the bank adds the hashing operands (e.g., the operands needed by the hashing algorithm to re-create the PID) to the other bank-related transaction details relating to the purchase. The transactions with their hashing operands are then stored in a transaction database (e.g., the transaction database 26 of FIG. 2).

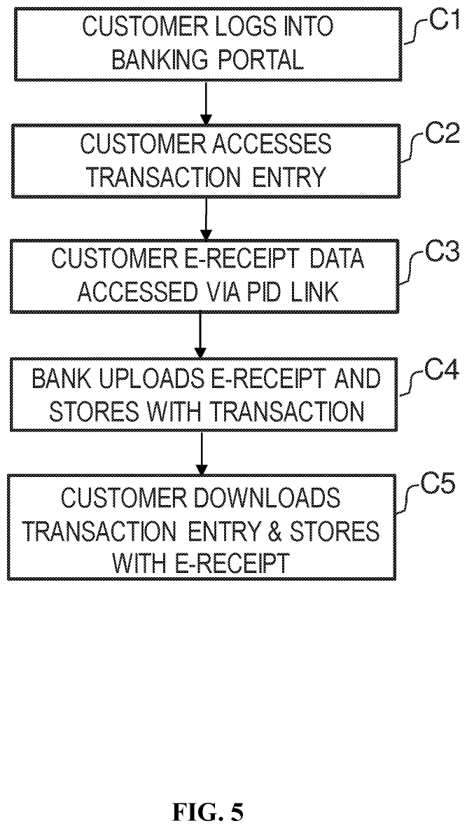

FIG. 5 is a flow diagram of a process that takes place when the customer wishes to view transaction activity in his or her account.

In Step C1, the customer logs on to a banking app or portal. In embodiments, the app/portal may not necessarily be related to banking. For example, in embodiments relating to inventory control, the customer may log on to an inventory control app/portal.

In Step C2, a transaction associated with a purchase is accessed (e.g., viewed as a line item in a bank statement or other list of transactions). The customer sees both the bank's usual transaction details and also a link to the e-receipt data, the link containing the unique PID that has been calculated on the fly from a copy of the hashing algorithm held by the bank, or supplied by the bank to the customer (e.g., as a browser add-on component). The customer is thus able to instantly index and view the e-receipt from and with the bank transaction.

In Step C3, the customer activates the link provided by the bank and thereby accesses the e-receipt. For example, if the bank statement has a simple view and a detailed view, then the e-receipt data may be hidden in the simple view and revealed in the detailed view. Another option would be for transactions that have an e-receipt to be marked with a link which the customer can select to cause the e-receipt data to be displayed (e.g., as a pop-up or as an indented extra detail in the line item for the transaction) to create a comprehensive transaction display (e.g., to concurrently display both the e-receipt and the transaction entry).

Optionally, the interaction between bank and customer in the online session may continue to allow the customer's e-receipts to be uploaded into the bank system and integrated with the transaction entries using the common links and/or the bank's transaction data to be downloaded to the customer where it is integrated with the e-receipts using the common links. The former is shown in Step C4 and the latter in Step C5.

An advantage of this approach is that the PID can be generated by both the merchant and the bank independently, thus eliminating any requirement for embedding the PID into the e-receipt or having to store the PID alongside the transaction, or even having to communicate the PID between the merchant and the bank (which would require changing the bank-to-merchant protocol that is currently used for purchasing).

A parallel set of embodiments may be envisaged in which, instead of the PIDs being calculated on demand, PIDs are calculated and stored for later look up. For example, the bank could calculate the PID for a transaction when it first generates a transaction entry for a purchase and associate the PID with the transaction entry (e.g., by indexing or simply saving the PID as part of the transaction entry). In such parallel embodiments where the PIDs are precalculated and stored by one of the parties, the operand values that would otherwise be stored by that party could optionally be deleted.

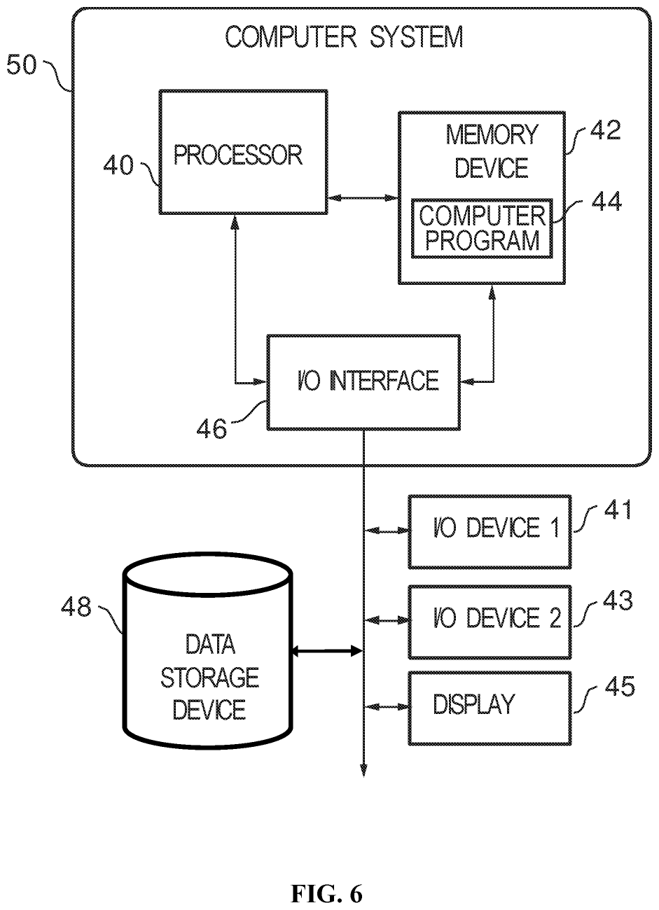

FIG. 6 shows a generic computing device 50, which may be one of the above-mentioned bank system 10, POS terminal 20, customer device 30, or part thereof. The computing device 50 comprises a processor 40 to provide a processor resource coupled through an I/O interface 46 to one or more external devices such as I/O devices 41, 43, and a display device 45. The processor 40 may also be connected to one or more memory devices 42. At least one memory device 42 to provide a memory resource contains a stored computer program 44, which is a computer program that comprises computer-executable instructions. The data storage devices 48 may store the computer program 44. The computer program 44 stored in the storage devices 48 is configured to be executed by processor 40 via the memory devices 42. The processor 40 executes the stored computer program 44.

All or part of the logical process steps of the preferred embodiment may be alternatively embodied in a logic apparatus, or a plurality of logic apparatus, comprising logic elements arranged to perform the logical process steps of the method and that such logic elements may comprise hardware components, firmware components or a combination thereof.

All or part of the logic components of the preferred embodiment may be alternatively embodied in logic apparatus comprising logic elements to perform the steps of the method, and that such logic elements may comprise components such as logic gates in, for example, a programmable logic array (FPGA) or application-specific integrated circuit (ASIC). Such a logic arrangement may further be embodied in enabling elements for temporarily or permanently establishing logic structures in such an array or circuit using, for example, a virtual hardware descriptor language, which may be stored and transmitted using fixed or transmittable carrier media.

In a further alternative embodiment, the present invention may be realized in the form of a computer-implemented method of deploying a service comprising steps of deploying computer program operable to, when deployed into a computer infrastructure and executed thereon, cause the computing device to perform all the steps of the method.

The method and components of the preferred embodiment may alternatively be embodied fully or partially in a parallel computing system comprising two or more processors for executing parallel software. Additionally, in embodiments, multiple steps of the method may be performed simultaneously using parallelism at a processor (e.g., using SIMD instructions).

A further embodiment of the invention is a computer program product defined in terms of a system and method. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device.

The present disclosure may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is to be understood that although this disclosure includes a detailed description on cloud computing, implementation of the teachings recited herein are not limited to a cloud computer system. Rather, embodiments of the present invention are capable of being implemented in conjunction with any other type of computer system now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computer system is service oriented with a focus on statelessness, low coupling, modularity, and semantic interoperability. At the heart of cloud computing is an infrastructure that includes a network of interconnected nodes.

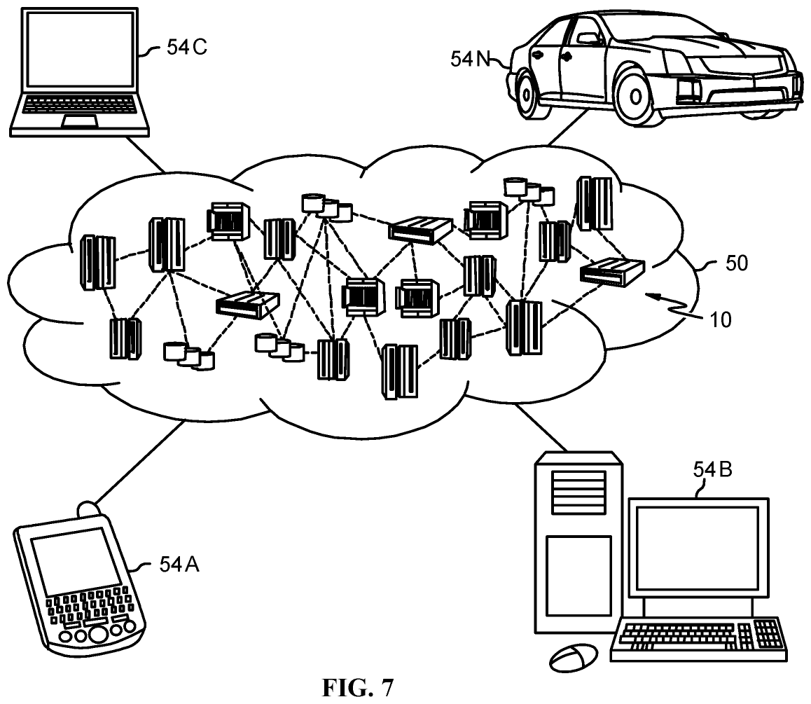

Referring now to FIG. 7, illustrative cloud computer system 50 is depicted. As shown, cloud computer system 50 includes one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computer system 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 100 and cloud computer system 50 can communicate with any type of computerized device over any type of network and/or network addressable connection (e.g., using a web browser).

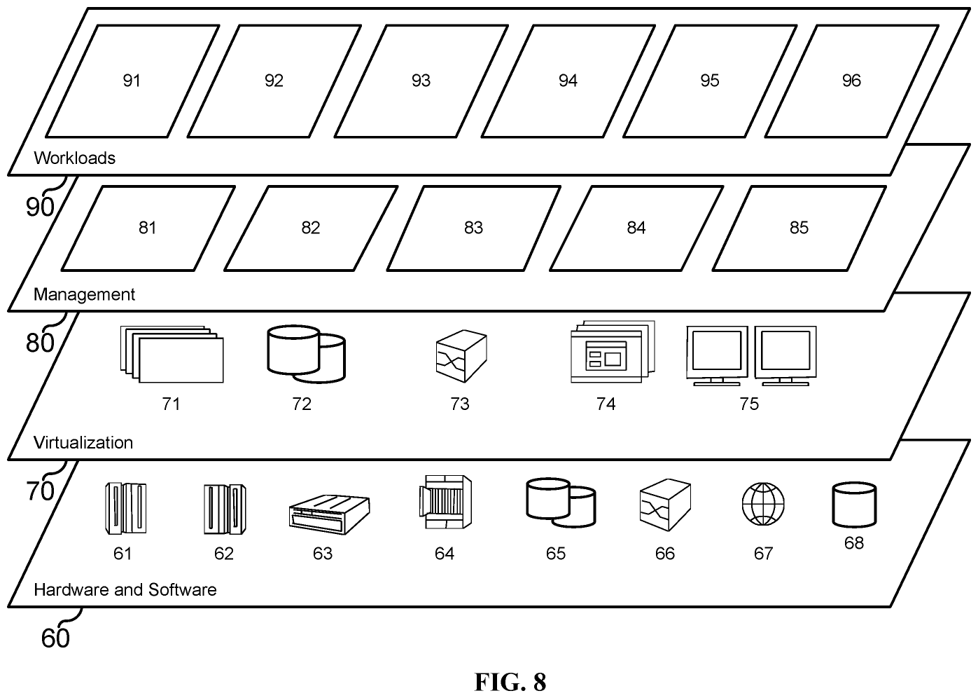

Referring now to FIG. 8, a set of functional abstraction layers provided by cloud computer system 50 (FIG. 7) is shown. It should be understood in advance that the components, layers, and functions shown in FIG. 8 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computer system. Metering and Pricing 82 provide cost tracking as resources are utilized within the cloud computer system, and billing or invoicing for consumption of these resources. In one example, these resources may include application software licenses. Security provides identity verification for cloud consumers and tasks, as well as protection for data and other resources. User portal 83 provides access to the cloud computer system for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computer system may be utilized. Examples of workloads and functions which may be provided from this layer include: mapping and navigation 91; software lifecycle management 92; virtual classroom education delivery 93; data analytics processing 94; transaction processing 95 and bank systems, POS terminals, customer devices or third party service providers 96 according to embodiments of the disclosure.

It will be clear to one skilled in the art that many improvements and modifications can be made to the foregoing exemplary embodiment without departing from the scope of the present disclosure.

What is claimed is:

1. A method for generating and displaying comprehensive transaction information, the method comprising:
generating, by a first device, an electronic receipt including a set of operands required by a hashing algorithm, wherein executing the hashing algorithm results in a unique purchase identifier (PID) for a first transaction;
transmitting the electronic receipt to a second device;
storing the electronic receipt in an electronic receipt storage;
transmitting one or more operands of the set of operands from the first device to a third device;
generating, by the third device, a transaction entry for the transaction, the transaction entry including the set of operands, wherein at least one operand of the set of operands is pre-shared between the first and third devices; and
storing the transaction entry in a transaction database.

2. The method of claim 1, wherein the first device executes the hashing algorithm using the set of operands to generate the PID, and wherein generating the PID includes creating a unique resource location (URL) associated with the PID.

3. The method of claim 1, wherein the third device has a copy of the hashing algorithm and executes the hashing algorithm using the set of operands to generate a duplicate PID.

4. The method of claim 3, further comprising:
accessing, using the second device, the transaction database;
matching, using the second device, the duplicate PID to the PID; and
associating, using the match, the electronic receipt with the transaction entry.

5. The method of claim 1, wherein at least one of the pre-shared operands is a salt.

6. The method of claim 5, wherein the first device is a merchant device, the second device is a customer device, and the third device is a bank device.

7. The method of claim 5, wherein the set of operands further includes a bank account identifier, a merchant identifier, a purchase value amount, a date/time stamp, and a salt.

8. The method of claim 7, wherein the set of operands further includes GPS coordinates of a transaction, a currency type, and a payment method type.

9. The method of claim 4, further comprising displaying, concurrently to a user, the electronic receipt and the transaction entry.

10. A system for generating and displaying comprehensive transaction information, wherein the system includes at least three devices, wherein each device further includes a memory with program instructions stored thereon and a processor in communication with the memory, and wherein the devices of the system are configured to execute the program instructions to:
generate, at a first device, an electronic receipt including a set of operands required by a hashing algorithm, wherein executing the hashing algorithm results in a unique purchase identifier (PID) for a first transaction;
transmit the electronic receipt to a second device;
store the electronic receipt in an electronic receipt storage;
transmit one or more operands of the set of operands from the first device to a third device;
generate, at the third device, a transaction entry for the transaction, the transaction entry including the set of operands, wherein at least one operand of the set of operands is pre-shared between the first and third devices; and
store the transaction entry in a transaction database.

11. The system of claim 10, wherein the first device executes the hashing algorithm using the set of operands to generate the PID, and wherein generating the PID includes creating a unique resource location (URL) associated with the PID.

12. The system of claim 10, wherein the third device has a copy of the hashing algorithm and executes the hashing algorithm using the set of operands to generate a duplicate PID.

13. The system of claim 12, wherein the program instructions further cause the system to:
access, using the second device, the transaction database;
match, using the second device, the duplicate PID to the PID; and
associate, using the match, the electronic receipt with the transaction entry.

14. The system of claim 10, wherein the set of operands further includes a bank account identifier, a merchant identifier, a purchase value amount, a date/time stamp, a salt, GPS coordinates of a transaction, a currency type, and a payment method type.

15. The system of claim 13, wherein the program instructions further cause the system to display, concurrently to a user, the electronic receipt and the transaction entry.

16. A computer program product for generating and displaying comprehensive transaction information, the computer program product comprising a computer readable storage medium having program instructions embodied therewith, the program instructions executable by a set of three or more devices to cause the set of devices to:
generate, at a first device, an electronic receipt including a set of operands required by a hashing algorithm, wherein executing the hashing algorithm results in a unique purchase identifier (PID) for a first transaction;
transmit the electronic receipt to a second device;
store the electronic receipt in an electronic receipt storage;
transmit one or more operands of the set of operands from the first device to a third device;
generate, at the third device, a transaction entry for the transaction, the transaction entry including the set of operands, wherein at least one operand of the set of operands is pre-shared between the first and third devices; and
store the transaction entry in a transaction database.

17. The computer program product of claim 16, wherein the third device has a copy of the hashing algorithm and executes the hashing algorithm using the set of operands to generate a duplicate PID.

18. The computer program product of claim 17, wherein the program instructions further cause one or more devices of the set of devices to:
access, using the second device, the transaction database;
match, using the second device, the duplicate PID to the PID; and
associate, using the match, the electronic receipt with the transaction entry.

19. The computer program product of claim 18, wherein the set of operands further includes a bank account identifier, a merchant identifier, a purchase value amount, a date/time stamp, a salt, GPS coordinates of a transaction, a currency type, and a payment method type.

20. The computer program product of claim 18, wherein the program instructions further cause the system to display, concurrently to a user, the electronic receipt and the transaction entry.
